(19) United States
(12) Patent Application Publication
(10) Pub. No.: US 2013/0037541 A1
(43) Pub. Date: Feb. 14, 2013

(54) BEZEL ASSEMBLY FOR ELECTRONIC DEVICE

(71) Applicant: YUN-LUNG CHEN, Tu-Cheng (TW)

(72) Inventor: YUN-LUNG CHEN, Tu-Cheng (TW)

(73) Assignee: HON HAI PRECISION INDUSTRY CO., LTD., Tu-Cheng (TW)

(21) Appl. No.: 13/451,805

(22) Filed: Apr. 20, 2012

(30) Foreign Application Priority Data
Aug. 9, 2011 (CN) 201110226893.8

(51) Int. Cl. H02G 3/14

(52) U.S. Cl. 220/241

(57) ABSTRACT

A bezel assembly includes a panel, a shielding member attached to the panel, and a resilient member located between the panel and the shielding member. The panel includes a driving portion. The resilient member includes a mounting arm, an abutting arm, and a resilient portion connected to the mounting arm and the abutting arm. The abutting arm includes a free end, and the driving portion is adapted to urge the abutting arm to deform the resilient portion.

### BACKGROUND

1. Technical Field

The present disclosure relates to electronic device enclosures, more particularly to a bezel assembly.

2. Description of Related Art

A panel of a computer case often includes an opening for an optical disk drive to move in or out of the computer case. A decorating plate and a shielding plate are used to shield the opening. Usually, the decorating plate is secured to an interior of the shielding plate using clipping members. When the shielding plate needs to be maintained or disassembled, the clipping members are disengaged from the decorating plate after the decorating plate is disengaged from the computer case. Therefore, it is inconvenient.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, cutaway view of a bezel assembly in accordance with an embodiment.

FIG. 2 is similar to FIG. 1, shown in a different aspect.

FIG. 3 is an assembled view of FIG. 1, and a shielding member of the bezel assembly is located in an open position relative to a panel of the bezel assembly.

FIG. 4 is assembled view to FIG. 1, and the shielding member is located in a center position relative to the panel.

FIG. 5 is similar to FIG. 4, shown in a different aspect.

FIG. 6 is an assembled view of FIG. 1, and the shielding member is located in a closed position relative to the panel.

FIG. 7 is a partial cross sectional view of FIG. 6 along the line VII-VII.

FIG. 8 is similar to FIG. 6, shown in a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

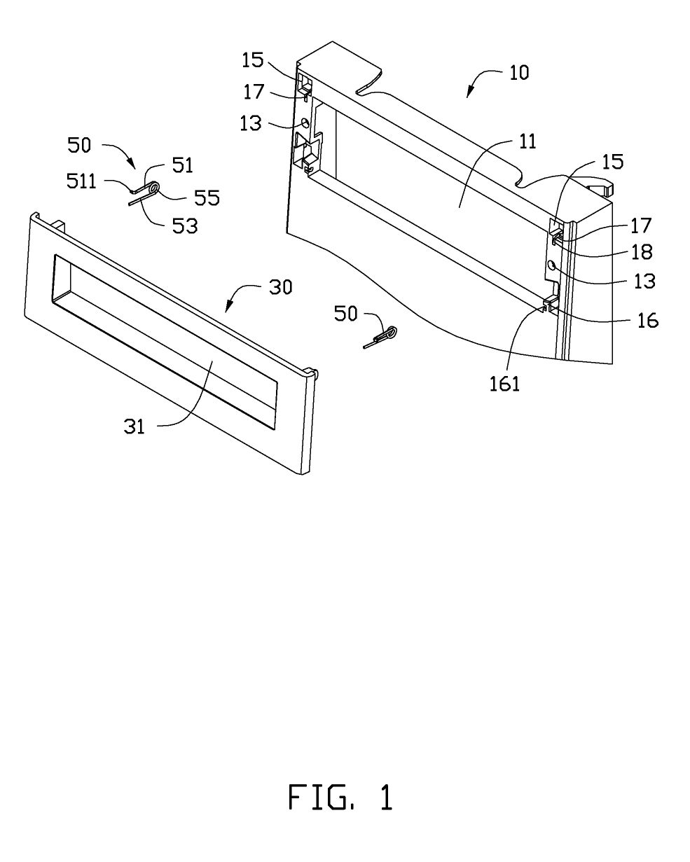

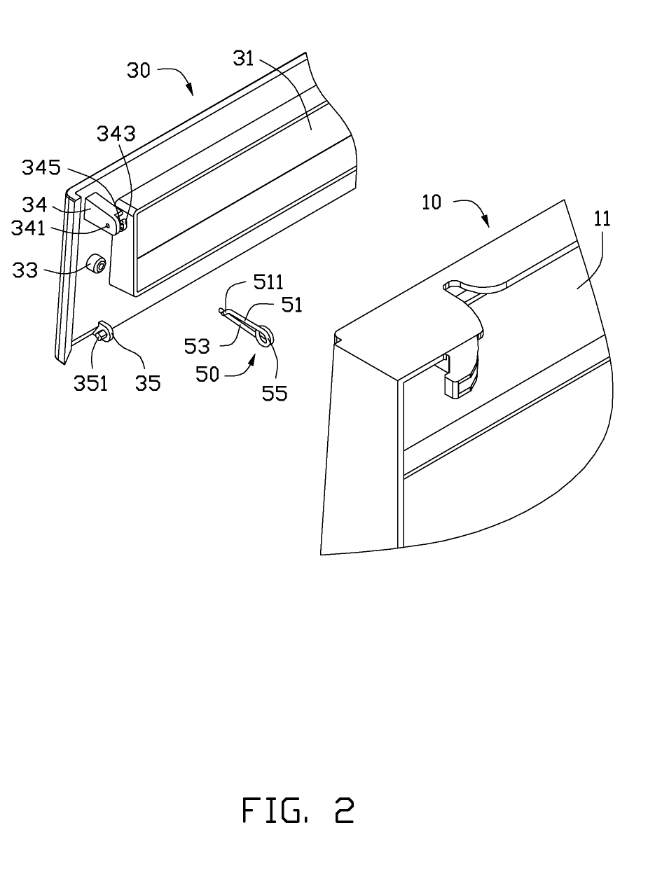

FIGS. 1 and 2, show a bezel assembly in accordance with an embodiment including a panel 10, a shielding member 30 attached to the panel 10, and two resilient members 50 located between the panel 10 and the shielding member 30. In one embodiment, the panel 10 is a decorating panel of a computer case.

The panel 10 defines an opening 11 and two positioning holes 13 located on opposite sides of the opening 11. The opening 11 is used for receiving an optical disk drive. A receiving hole 15 is defined in the panel 10 above each positioning hole 13, and a protruding block 16 is located below each positioning hole 13. A concave slot 161 is defined in the protruding block 16 towards the opening 11. An accommodating slot 18 is defined in the panel 10 communicating with the receiving hole 15. A driving portion 17 is located on the bottom portion of the accommodating slot 18. In one embodiment, the driving portion 17 includes an arcuate surface.

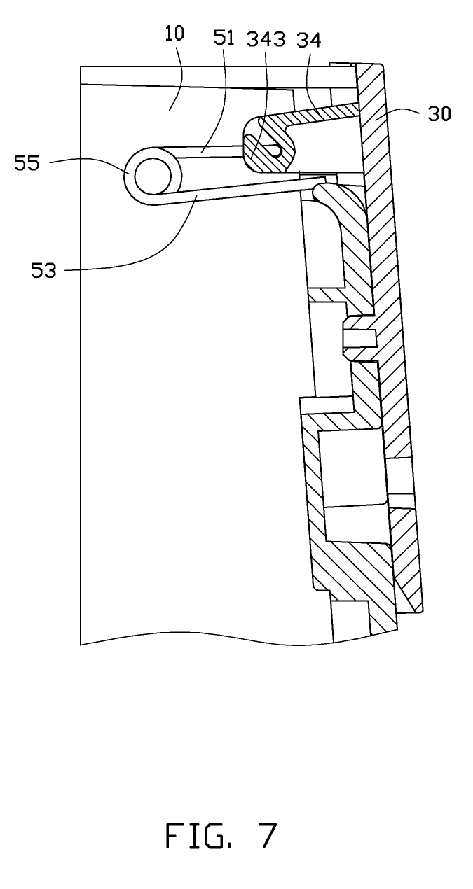

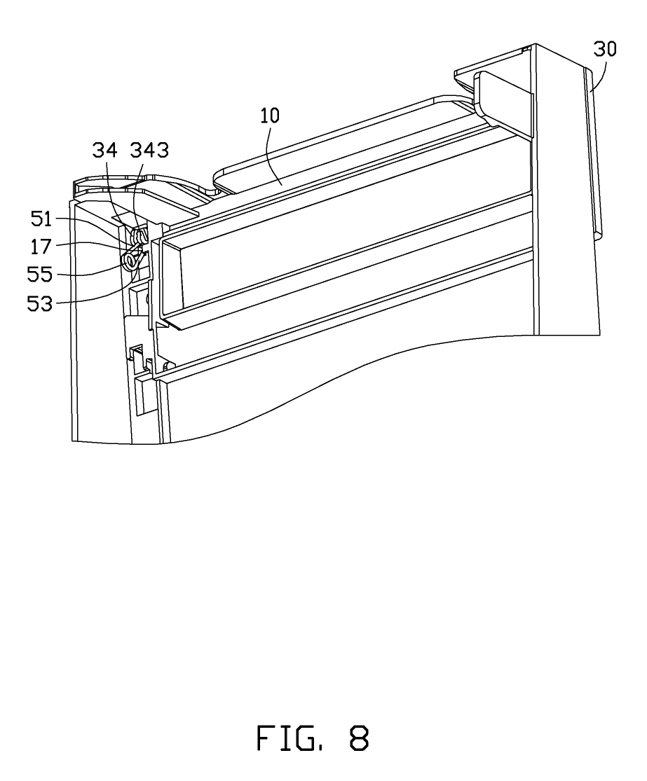

The shielding member 30 defines a through hole 31 corresponding to the opening 11, and two positioning posts 33 (only one is shown in FIGS. 1-8) are located on an inner surface of the shielding member 30. The two positioning posts 33 and the two positioning holes 13 cooperatively define a clipping device. In one embodiment, the clipping device is not limited to such a configuration and the positions can be changed according to other known techniques, such as hooks and clipping holes. A securing portion 34 and a mounting piece 35 are located on the shielding member 30. The mounting piece 35 is below the securing portion 34. A pivoting hole 341 is defined in the securing portion 34, and a limiting portion 343 is located on a side of the pivoting hole 341. A mounting post 351 extends from the mounting piece 35, and the mounting post 351 corresponds to the concave slot 161. In one embodiment, a cross-section of the limiting portion 343 is arcuate, and a receiving slot 345 is defined between the limiting portion 343 and the securing portion 34.

Each resilient member 50 includes a mounting arm 51, an abutting arm 53, and a resilient portion 55 connected to the mounting arm 51 and the abutting arm 53. A pivoting portion 511 extends from a free end of the mounting arm 51. In one embodiment, the resilient member 50 is a torsion spring, the pivoting portion 511 is substantially perpendicular to the mounting arm 51, and a length of the mounting arm 51 is less than that of the abutting arm 53.

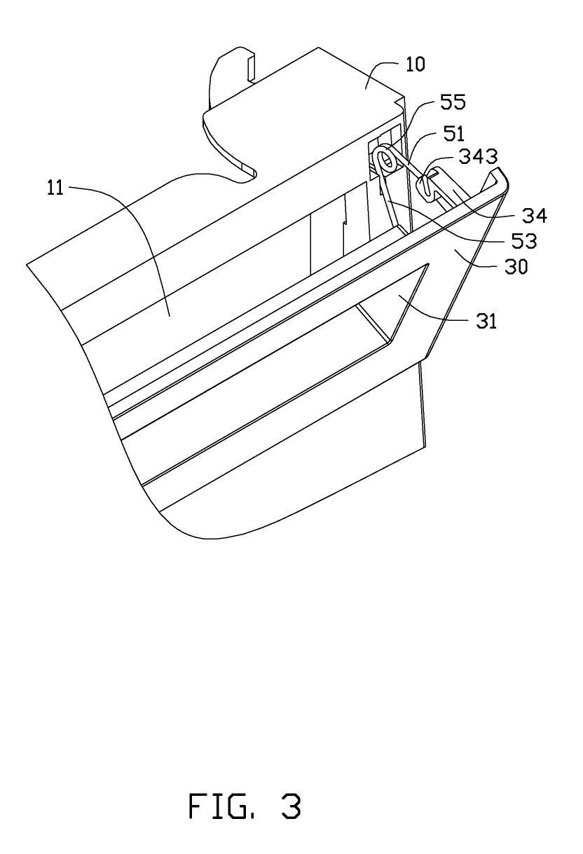

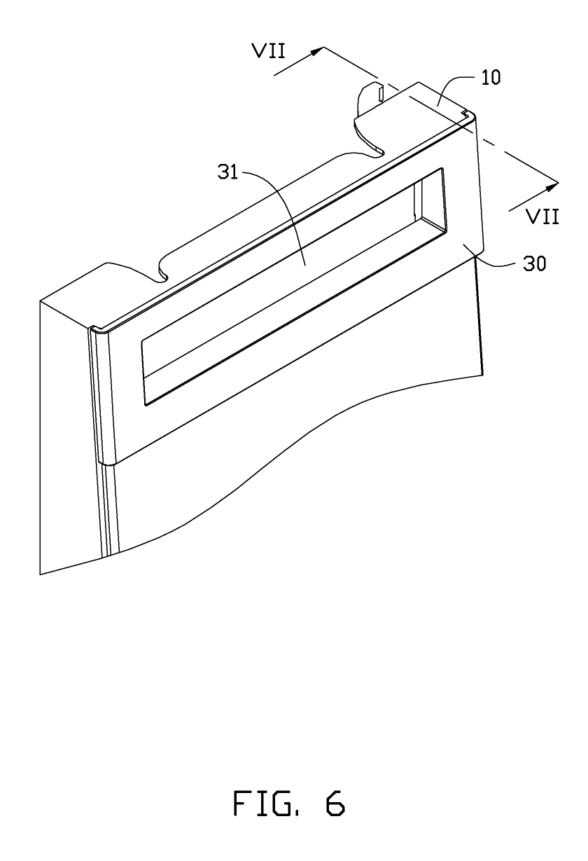

Referring to FIGS. 3-8, in assembly, the shielding member 30 covers the panel 10, and the mounting post 351 is received in the concave slot 161. The resilient member 50 is received in the receiving slot 345, and the pivoting portion 511 is rotatably received in the pivoting hole 341. The abutting arm 53 elastically abuts the driving portion 17. The shielding member 30 can be located in an open position (see FIG. 3) and a closed position (see FIG. 6) relative to the panel 10. In the open position, the positioning post 33 is disengaged from the positioning hole 13, the resilient member 50 is in an original state, and the abutting arm 53 is opened relative to the mounting arm 51. In one embodiment, an arcuate angle is defined between the abutting arm 53 and the mounting arm 51. In the closed position, the positioning post 33 is received in the positioning hole 13, the securing portion 34 extends through the receiving hole 15, the resilient member 50 is deformed, and the abutting arm 53 is closed relative to the mounting arm 51.

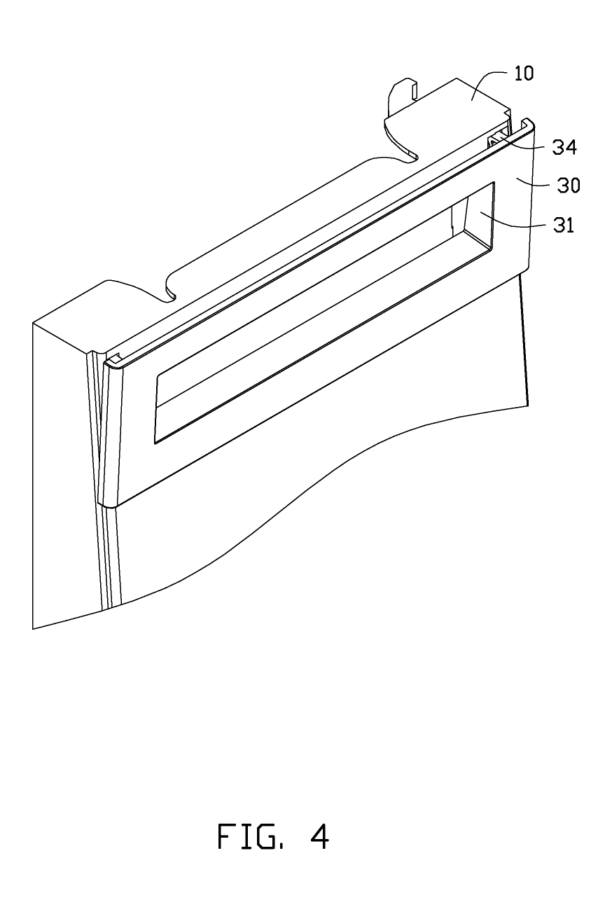

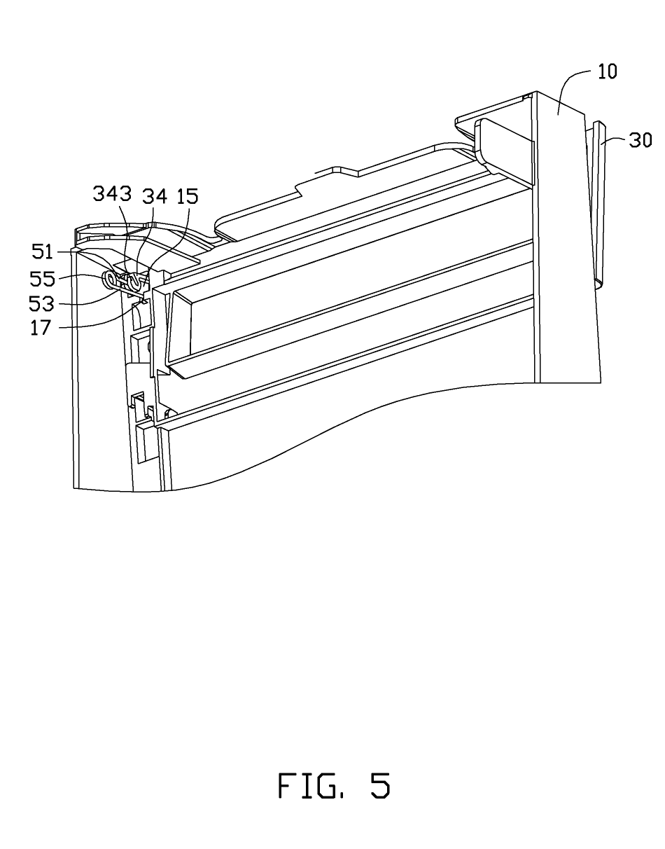

The shielding member 30 is pressed towards the panel 10 when it moves from the open position to the closed position, until the abutting arm 53 abuts the driving portion 17. The shielding member 30 is further pressed, and the abutting arm 53 is moved along the driving portion 17 in the accommodating slot 18. The resilient member 50 is deformed, and the pivoting portion 511 is rotated in the pivoting hole 341, until the resilient member 50 extends through the receiving hole 15. Then, the shielding member 30 is positioned in a center position (see FIGS. 4-5) between the open position and the closed position. The mounting arm 51 is substantially parallel to the abutting arm 53 when the shielding member 30 is located in the center position. The shielding member 30 is further pressed, until the securing portion 34 and the limiting portion 343 are both clipped into the receiving hole 15 and the positioning post 33 is engaged in the positioning hole 13. The mounting arm 51 and the abutting arm 53 are both slanted downward relative to the panel 10, and the shielding member 30 is thus secured to the panel 10.

In disassembly, the shielding member 30 is moved away from the panel 10, to disengage the securing portion 34 and the limiting portion 343 from the receiving hole 15.

The abutting arm 53 is gradually opened relative to the mounting arm 51, until the shielding member 30 is located in the center position. The shielding member 30 is further moved, until positioned in the opening position. The mounting post 351 is disengaged from the concave slot 161, and the shielding member 30 can be detached from the panel 10.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A bezel assembly comprising:
a panel comprising a driving portion;
a shielding member attached to the panel; and
a resilient member, located between the panel and the shielding member, comprising a mounting arm, an abutting arm, and a resilient portion connected to the mounting arm and the abutting arm;
wherein the abutting arm comprising a free end, and the driving portion is adapted to urge the abutting arm to deform the resilient portion.

2. The bezel assembly of claim 1, wherein the resilient member is a torsion spring.

3. The bezel assembly of claim 1, wherein the driving portion comprises an arcuate surface, and the driving portion urges the abutting arm with the arcuate surface.

4. The bezel assembly of claim 1, wherein the mounting arm and the abutting arm are both slanted relative to the panel.

5. The bezel assembly of claim 1, wherein a positioning hole is defined in the panel, a positioning post is located on the shielding member, and the positioning post is received in the positioning hole.

6. The bezel assembly of claim 1, wherein the panel defines an accommodating slot, and the driving portion is located on the bottom of the accommodating slot.

7. The bezel assembly of claim 6, wherein the panel defines a receiving hole communicating with the accommodating slot, the driving portion is located on a side of the driving portion, and the resilient member extends through the receiving hole.

8. The bezel assembly of claim 7, wherein the shielding member comprises a securing portion to secure the mounting arm, and the securing portion is received in the receiving hole.

9. The bezel assembly of claim 8, wherein the securing portion comprises a limiting portion, a receiving slot is defined between the limiting portion and the securing portion, and the mounting arm is engaged in the receiving slot.

10. The bezel assembly of claim 9, wherein the securing portion defines a pivoting hole, a pivoting portion extends from a free end of the mounting arm, and the pivoting portion is rotatably engaged in the pivoting hole.

11. A bezel assembly comprising:
a panel comprising a driving portion and a positioning post;
a shielding member comprising a positioning hole;
a resilient member, located between the panel and the shielding member, comprising a mounting arm, an abutting arm, and a resilient portion connected to the mounting arm and the abutting arm; and the abutting arm comprises a free end;
wherein the shielding member is located in an open position and a closed position with the driving portion urging the abutting arm; when the shielding member is located in the open position, the positioning post is disengaged from the positioning hole, the resilient member is in an original state, and the abutting arm is opened relative to the mounting arm;
and when the shielding member is located in the closed position, the positioning post is engaged in the positioning hole, the resilient member is deformed, and the abutting arm is closed relative to the mounting arm.

12. The bezel assembly of claim 11, wherein the shielding member is positioned in a center position between the open position and the closed position, and the mounting arm is substantially parallel to the abutting arm when the shielding member is positioned in the center position

13. The bezel assembly of claim 11, wherein the resilient member is a torsion spring.

14. The bezel assembly of claim 11, wherein the driving portion comprises an arcuate surface, and the driving portion urges the abutting arm with the arcuate surface.

15. The bezel assembly of claim 11, wherein the panel defines an accommodating slot, and the driving portion is located on the bottom of the accommodating slot.

16. The bezel assembly of claim 15, wherein the panel defines a receiving hole communicating with the accommodating slot, the driving portion is located on a side of the driving portion, and the resilient member extends through the receiving hole.

17. The bezel assembly of claim 16, wherein the shielding member comprises a securing portion to secure the mounting arm, and the securing portion is received in the receiving hole.

18. The bezel assembly of claim 17, wherein the securing portion comprises a limiting portion, a receiving slot is defined between the limiting portion and the securing portion, and the mounting arm is engaged in the receiving slot.

19. The bezel assembly of claim 18, wherein the securing portion defines a pivoting hole, and a pivoting portion extends from a free end of the mounting arm, and is rotatably engaged in the pivoting hole.
